(19) United States
(12) Patent Application Publication
(10) Pub. No.: US 2014/0327739 A1
(43) Pub. Date: Nov. 6, 2014

(54) APPARATUS AND METHOD FOR RECEIVING 3D DIGITAL BROADCASTING, AND APPARATUS AND METHOD FOR CONVERTING IMAGE MODE

(71) Applicant: ELECTRONICS AND TELECOMMUNICATIONS RESEARCH INSTITUTE, Daejeon (KR)

(72) Inventors: Jin Hwan Lee, Daejeon (KR); Gwang Soon Lee, Daejeon (KR); Nam Ho Hur, Daejeon (KR)

(21) Appl. No.: 14/359,093

(22) PCT Filed: Nov. 2, 2012
(86) PCT No.: PCT/KR2012/009168

§ 371 Date: May 17, 2014

(30) Foreign Application Priority Data
Nov. 29, 2011 (KR) 10-2011-0125712

(51) Int. Cl. H04N 13/00; H04N 21/4402; H04N 21/81; H04N 21/434

(52) U.S. Cl. CPC H04N 13/0029; H04N 13/0059; H04N 21/4343; H04N 21/4348; H04N 21/4402; H04N 21/816
USPC 348/43

(57) ABSTRACT

An apparatus and method of receiving 3D digital broadcasting capable of frame compatibility and service compatibility even in the existing display apparatus, regardless of whether a 3D service mode is a frame-compatible or service-compatible, are provided. The apparatus of receiving broadcast may include: a broadcast signal receiving and demodulating unit that receives and demodulates broadcast signals to extract transport streams; a demultiplexing unit that extracts broadcast program information including a broadcast service mode, a video format and an encoding type of elementary streams, and elementary streams from the demodulated transport streams; and a video processing unit that processes the video signals and outputs the video signals to the display device, based on the broadcast program information obtained by the demultiplexing unit and the display mode of the apparatus of receiving broadcast set by a user.

### CROSS REFERENCE TO RELATED APPLICATIONS

The present application claims priority to International Application PCT/KR2012/009168, with an International Filing Date of Nov. 2, 2012, which claims the benefit of Korean Patent Application No. 10-2011-0125712 filed in the Korean Intellectual Property Office on Nov. 29, 2011, the entire contents of which are incorporated herein by reference.

### TECHNICAL FIELD

The present invention relates to an apparatus and a method of receiving a 3D digital broadcast, and more particularly, to an apparatus and a method of receiving a 3D digital broadcast capable of constructing video signals based on a video mode of received broadcast signals and a display mode of an apparatus of receiving a broadcast and outputting the video signals to a 3D display apparatus.

### BACKGROUND ART

A service mode used for 3D digital broadcast is largely divided into a frame-compatible mode and a service-compatible mode.

The frame-compatible (frame-compatible 3D) mode means a mode of reducing original resolution of left and right videos and constructing the left and right videos into a single video frame and is a 3D digital broadcast service mode that has been currently used worldwide. A video format mainly used in the frame-compatible mode is side-by-side and top-and-bottom. The side-by-side is a video format horizontally constructing the left and right videos in a single video frame and the top-and-bottom is a video format vertically constructing the left and right videos in a single video frame. In the frame-compatible mode, it can perform a receiving process even in the case of using an apparatus of receiving 2D digital broadcast according to the related art, because the video signals that are constructed as the same video frame as the existing digital broadcast, are encoded, transmitted and therefore. Most of the 3D display apparatuses support the frame-compatible mode and therefore, can receive 3D digital broadcast services as they are when the frame-compatible mode video signals that is received in and processed by the apparatus of receiving 2D digital broadcast according to the related art are displayed by a 3D display apparatus. Therefore, there is no need for a separate apparatus of receiving 3D digital broadcast in order to receive the frame-compatible 3D services. However, when the 3D video signals that are received in and processed by the apparatus of receiving 2D digital broadcast according to the related art are displayed by the 2D display apparatus rather than by the 3D display apparatus, a left video and a right video are horizontally or vertically displayed on one screen simultaneously and therefore, it is impossible to normally watch TV.

The 3D broadcast services can be made even by a frame sequential format that is a format of alternately constructing the left and right video frames sequentially without reducing the original resolution of the left and right videos. Even in the case of this format, the left and right videos are alternately displayed when the processed video signals are displayed by the 2D display apparatus rather than by the 3D display apparatus and therefore, it is impossible to normally watch TV. Therefore, the frame sequential format also belongs to a range of the frame-compatible mode in a broad sense.

The service-compatible (service-compatible 3D) mode is a mode of independently encoding and transmitting the left and right videos so as to be able to be compatible with the apparatus of receiving 2D digital broadcast according to the related art and is referred to as a dual stream mode in that the left video and the right video are independently encoded and transmitted. The service-compatible mode can be provided with 2D broadcast services when the apparatus of receiving 2D digital broadcast according to the related art processes only a stream corresponding to a base video (for example, left video) to display only a base video. In addition, the service-compatible mode performs transmitting processing on two video streams without reducing the original resolution of the left and right videos and therefore, can implement a high quality 3D broadcast service. On the other hand, in order to watch the 3D broadcast in the service-compatible mode, there is a need to use a 3DTV receiver or an apparatus of receiving 3D digital broadcast that can support the service-compatible mode, that is, receive and process a base video (for example, left video) stream and an additional video (for example, right video) stream simultaneously. Thereby, it is possible to normally receive the 3D broadcast service.

In this digital broadcast, the video signals are encoded and then, are transmitted as a MPEG-2 transport streams. In order to provide information on broadcast programs within the transport streams, there is a need to transmit the information by being carried on a program map table (PMT). In this case, the information on the broadcast programs may include information on the video mode of the received stream. The information on the video mode means information on whether the streams of the broadcast programs to be watched are the 2D video streams, the frame-compatible 3D video streams, or the service-compatible 3D video streams and information on whether the video streams are constructed by what 3D video format. The service-compatible 3D video streams include information on elementary streams of the base video and the additional video. In addition, the information on the broadcast programs includes information on whether the elementary streams are encoded by what encoding type.

When the video encoding type is MPEG-2, it is possible to transmit the information by being carried on the video mode on user_data within packetized elementary streams (PESs) and when the video encoding type is MPEG-4 AVC, it is possible to transmit the information by being carried on a frame packing arrangement Supplemental Enhancement Information (SEI) message within the PESs.

Many display apparatuses have an HDMI interface. In particular, the HDMI interface is standardized so as to process the 3D video signals from an HDMI version 1.4. In the HDMI 1.4, the side-by-side and top-and-bottom video formats that are the frame-compatible mode and a frame packing format are also standardized so as to pack the video signals transmitted in the service-compatible mode into a single frame without reducing the resolution and then, process the packed video signals.

### DISCLOSURE

### Technical Problem

The present invention provides an apparatus and a method of receiving 3D digital broadcast capable of receiving a frame-compatible 3D and a service-compatible 3D even in the existing display apparatus regardless of whether a 3D service mode is frame-compatible or service-compatible. That is, when using a receiving apparatus of the present invention, it is possible to normally watch TV in the existing 2D display apparatus even though the frame-compatible 3D broadcast signals are received and it is possible to normally watch 3D broadcast in the existing 3D display apparatus that does not support the service-compatible mode even though the service-compatible 3D broadcast signals are received.

To this end, there is a need to construct and output the video signals based on the identified video mode and the display mode set by the user after receiving the digital broadcast signals, identifying the video mode by analyzing the received streams, and processing the received streams based on the identified video mode and the display mode of the apparatus of receiving broadcast set by the user.

The present invention also provides an apparatus of receiving 3D digital broadcast capable of normally watching video regardless of a video mode of received video signals and a display mode of an apparatus of receiving broadcast.

The present invention also provides a method of receiving 3D digital broadcast capable of normally watching video regardless of a video mode of received video signals and a display mode of an apparatus of receiving broadcast.

### Technical Solution

In an aspect, an apparatus of receiving broadcast is provided. The apparatus includes: a broadcast signal receiving and demodulating unit that receives and demodulates broadcast signals to extract transport streams; a demultiplexing unit that extracts broadcast program information and elementary streams from the extracted transport streams; and a video processing unit that processes the elementary streams and constructs video signals, based on the extracted broadcast program information and display mode setting of the apparatus of receiving broadcast.

The broadcast program information may include at least one of information on a video mode of the received broadcast signals and information on an encoding type of the elementary streams.

The information on the video mode may include at least one of a broadcast service mode, a video format, information on elementary streams of a base video, and information on elementary streams of an additional video.

The demultiplexing unit may analyze at least one of a program map table (PMT) in the extracted transport streams, user_data within packetized elementary streams (PESs) or a frame packing arrangement SEI message, and extract information on the video mode of the received broadcast signals.

The video processing unit may construct 2D video signals when the extracted transport streams are 3D and the display mode setting of the apparatus of receiving broadcast is 2D, the video processing unit may process the elementary streams based on the video mode of the transport streams when the extracted transport streams are 3D and construct the video signals based on the display mode setting of the apparatus of receiving a broadcast regardless of the 3D service mode of the transport streams or the 3D video format, and the video processing unit may perform an interpolation function for reconstructing the video signals into original resolution, when the extracted transport streams are 3D video transport streams with reduced original resolution and the display mode setting of the apparatus of receiving broadcast is 2D. The video processing unit may perform a decimation function for converting the service-compatible 3D video signals into the frame-compatible 3D video signals, when the extracted transport streams are the service-compatible 3D video transport streams and the display mode setting of the apparatus of receiving broadcast is the frame-compatible 3D.

The video processing unit may include: a decoding unit that decodes the elementary streams, based on the broadcast program information obtained by the demultiplexing unit; a base video post-processing unit that post-processes a base video by interworking the base video frame memory; an additional video post-processing unit that post-processes an additional video by interworking the additional video frame memory; a video combining unit that reads the video signals of at least one of the base video frame memory and an additional video frame memory and constructs the video signals of video format to be displayed; and a video output unit that constructs and outputs the video signals so as to meet an interface standard of the video signals to be displayed.

In another aspect, a method of receiving broadcast is provided. The method includes: receiving and demodulating broadcast signals to extract transport streams; performing demultiplexing to extract broadcast program information and elementary streams from the extracted transport streams; and processing video to process the elementary streams and construct video signals, based on the extracted broadcast program information and display mode setting of an apparatus of receiving broadcast.

The broadcast program information may include at least one of information on a video mode of the received broadcast signals and information on an encoding type of the elementary streams. The information on the video mode may include at least one of a broadcast service mode, a video format, information on elementary streams of a base video, and information on elementary streams of an additional video.

In the demultiplexing, at least one of a program map table (PMT) in the extracted transport streams, user_data within packetized elementary streams (PESs) or a frame packing arrangement SEI message may be analyzed, and information on the video mode of the received broadcast signals may be extracted.

In the processing of the video, 2D video signals may be constructed when the extracted transport streams are 3D and the display mode setting of the apparatus of receiving broadcast is 2D. In the processing of the video, the elementary streams may be processed based on the video mode of the transport streams when the extracted transport streams are 3D and the video signals may be constructed based on the display mode setting of the apparatus of receiving broadcast regardless of the 3D service mode of the transport streams or the 3D video format, in the video processing step, an interpolation function for reconstructing the video signals into original resolution may be performed when the extracted transport streams are 3D video transport streams with reduced original resolution and the display mode setting of the apparatus of receiving broadcast is 2D. A decimation function for converting the service-compatible 3D video signals into the frame-compatible 3D video signals may be performed, when the extracted transport streams are the service-compatible 3D video transport streams and the display mode setting of the apparatus of receiving broadcast is the frame-compatible 3D.

The video processing step may include: decoding the elementary streams, based on the broadcast program information obtained in the demultiplexing; post-processing a base video by interworking the base video frame memory; post-processing an additional video by interworking the additional video frame memory; performing combining videos to read the video signals of at least one of the base video frame memory and an additional video frame memory and construct the video signals of video format to be displayed; and constructing and outputting the video signals so as to meet an interface standard of the video signals to be displayed.

### Advantageous Effects

As set forth above, according to the apparatus and method of receiving 3D digital broadcast of the embodiment of the present invention, it is possible to perform frame compatibility and service compatibility even in the existing display apparatus, regardless of whether the 3D service mode is the frame-compatible mode or the service-compatible mode. That is, it is possible to normally watch TV in the existing 2D display apparatus even though the frame-compatible 3D broadcast signals are received and it is possible to normally watch 3D broadcast in the existing 3D display apparatus that does not support the service-compatible mode even though the service-compatible 3D broadcast signals are received.

Therefore, a viewer can use the existing display apparatus again without being replaced even when the 3D service mode is changed, thereby saving costs and a broadcast provider can reduce a burden when selecting or changing the 3D service mode.

### DESCRIPTION OF DRAWINGS

FIG. 1 is a block diagram showing a configuration of an apparatus of receiving 3D digital broadcast according to an exemplary embodiment of the present invention.

FIG. 2 is a flow chart for describing an operational flow of a video processing unit shown in FIG. 1.

FIG. 3 is a flow chart of a method of receiving 3D digital broadcast according to an exemplary embodiment of the present invention.

### DETAILED DESCRIPTION

Since the present invention may be variously modified and have several exemplary embodiments, specific exemplary embodiments will be shown in the accompanying drawings and be described in detail.

However, it is to be understood that the present invention is not limited to the specific exemplary embodiments, but includes all modifications, equivalents, and substitutions included in the spirit and the scope of the present invention.

Terms used in the specification, ‘first’, ‘second’, etc., can be used to describe various components, but the components are not to be construed as being limited to the terms. The terms are only used to differentiate one component from other components. For example, the ‘first’ component may be named the ‘second’ component and the ‘second’ component may also be similarly named the ‘first’ component, without departing from the scope of the present invention. The term ‘and/or’ includes a combination of a plurality of items or any one of a plurality of terms.

It is to be understood that when one element is referred to as being “connected to” or “coupled to” another element, it may be connected directly to or coupled directly to another element or be connected to or coupled to another element, having the other element intervening therebetween. On the other hand, it is to be understood that when one element is referred to as being “connected directly to” or “coupled directly to” another element, it may be connected to or coupled to another element without the other element intervening therebetween.

Terms used in the present specification are used only in order to describe specific exemplary embodiments rather than limiting the present invention. Singular forms are intended to include plural forms unless the context clearly indicates otherwise. It will be further understood that the terms “comprises” or “have” used in this specification, specify the presence of stated features, steps, operations, components, parts, or a combination thereof, but do not preclude the presence or addition of one or more other features, numerals, steps, operations, components, parts, or a combination thereof.

Unless indicated otherwise, it is to be understood that all the terms used in the specification including technical and scientific terms has the same meaning as those that are understood by those who are skilled in the art. It must be understood that the terms defined by the dictionary are identical with the meanings within the context of the related art, and they should not be ideally or excessively formally defined unless the context clearly dictates otherwise.

Hereinafter, exemplary embodiments of the present invention will be described in more detail with reference to the accompanying drawings. In order to facilitate the general understanding of the present invention in describing the present invention, through the accompanying drawings, the same reference numerals will be used to describe the same components and an overlapped description of the same components will be omitted.

Specific terms will be used in the exemplary embodiments of the present invention for clarity of the contents therein. However, the present invention is not limited to the specific terms selected therein but includes all technical synonyms operating in the same method so that each of the specific terms accomplish similar objects.

Apparatus of Receiving 3D Digital Broadcast

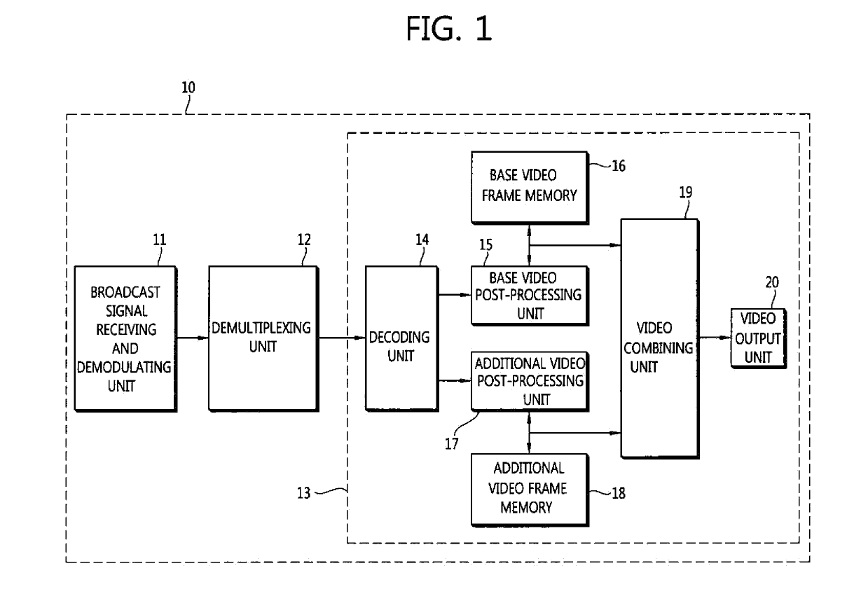

FIG. 1 is a block diagram showing a configuration of an apparatus of receiving 3D digital broadcast according to an exemplary embodiment of the present invention.

As shown in FIG. 1, an apparatus of receiving 3D digital broadcast according to an exemplary embodiment of the present invention identifies a video mode (at least one of a broadcast service mode, a video format, information on elementary streams of a base video, or information on elementary streams of an additional video) by analyzing streams of received broadcast signals, processes the streams based on an identified video mode and a display mode (video format) of an apparatus of receiving broadcast set by a user, and constructs and outputs video signals based on the identified video mode and the display mode set by the user.

Referring to FIG. 1, an apparatus 10 of receiving 3D digital broadcast receives broadcast programs selected by a user, processes broadcast signals based on information on a video mode included in the streams of the received broadcast signals and the display mode set by the user, and constructs and outputs the video signals.

As shown in FIG. 1, the apparatus 10 of receiving 3D digital broadcast may include a broadcast signal receiving and demodulating unit 11, a demultiplexing unit 12, and a video processing unit 13. The video processing unit 13 may include a decoding unit 14, a base video post-processing unit 15, a frame memory for a base video 15, an additional video post-processing unit 17, a frame memory for an additional video 18, a video combining unit 19, and a video output unit 20.

The broadcast signal receiving and demodulating unit 11 receives a broadcast channel selected by a user, performs a demodulation process, and transmits transport streams of user desired broadcast programs to the demultiplexing unit 12.

The demultiplexing unit 12 acquires broadcast program information including at least one of information on a broadcast service mode, a video format and an encoding type of elementary streams from the transport streams, extracts the elementary streams from the transport streams, and transmits the broadcast program information and the elementary streams to the video processing unit 13.

When the broadcast service mode is 2D or the frame-compatible 3D, two elementary streams (video, audio) are generally present; and when the broadcast service mode is the service-compatible 3D, three elementary streams (base video, additional video, audio) are present.

The video processing unit 13 performs video processing such as decoding on the elementary streams, based on the broadcast program information transmitted from the demultiplexing unit 12 and the display mode of an apparatus of receiving broadcast set by the user.

In addition, the video processing unit 13 may use at least one of information on a broadcast service mode or a video format that is present in user data within PES when the encoding type of the elementary stream is MPEG-2 and may use at least one of information on a broadcast service mode or a video format that is present in a frame packing arrangement (SEI) message within the PES when the encoding type of the elementary streams is MPEG-4 AVC.

Even though the broadcast service mode is the service-compatible 3D, the video processing unit 13 may process the videos in the same manner as the 2D broadcast services that are without needing to process the additional video, when the user wants to receive services using 2D.

The decoding unit 14 decodes each elementary stream based on the encoding type of each elementary stream acquired by the demultiplexing unit 12 and then, transmits the base video among the decoded video signals to the base video post-processing unit 15 and the additional video to the additional video post-processing unit 17. Audio elementary streams are decoded based on the encoding type of the audio elementary streams and then, audio signals are transmitted to the video output unit 20.

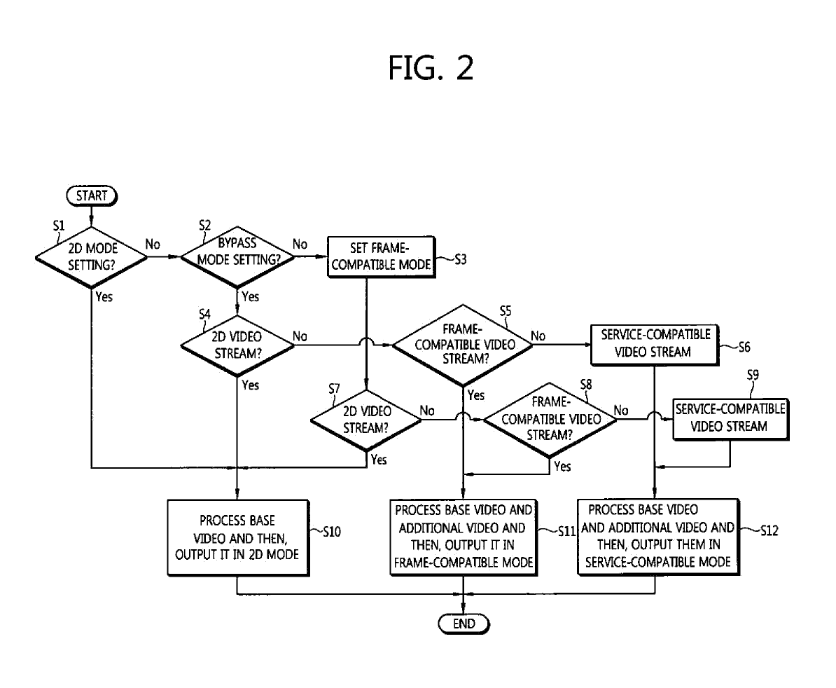

FIG. 2 is a flow chart for describing an operational flow of a video processing unit shown in FIG. 1 according to an exemplary embodiment of the present invention.

As shown in FIG. 2, the video processing unit 13 may be differently operated, based on the display mode of the apparatus of receiving digital broadcast set by a user depending on whether the display apparatus supports services, and the like (S1, S2, and S3). The user desired display mode may be set by being largely divided into three modes such as a 2D mode (S1), a bypass mode (S2), or a frame-compatible mode (S3), and the video mode may be selected and set by a remote controller or a switch. In addition, the frame-compatible mode may be set by being divided into side-by-side, top-and-bottom, or frame sequential formats, and the like.

When the user sets the display mode as 2D (S1); or when the user sets the display mode as a bypass mode (S2) but the video mode of the received stream is 2D (S4); or when the user sets the display mode as the frame-compatible mode (S3) but the video mode of the received stream is 2D (S7), the base video is subjected to the video processing and then, is output as the 2D mode (S10).

When the user sets the display mode as the bypass mode (S2), the video mode of the received stream is subjected to video processing as it is and then, is output as the same video mode as the input video (S2, S4, S5, S6, S10, S11, and S12). That is, when the user sets the display mode as the bypass mode (S2) and the video mode of the received stream is 2D (S4), the base video (2D video) is subjected to the video processing and then, output as the 2D mode (S10); when the user sets the display mode as the bypass mode (S2) and the video mode of the received stream is the frame-compatible mode (S5), the base video and the additional video is processed and then, outputs as the frame-compatible mode (S11); and when the user sets the display mode as the bypass mode (S2) and the video mode of the received stream is the service-compatible mode (S6), the base video and the additional video are processed and then, outputs as the service-compatible mode (S12). When the video mode of the received stream is the service-compatible (S9), it is desirable that the video signals are constructed and output into the frame packing format. In other words, when the display apparatus does not support the frame packing format for the processed video signals, the display mode may be preferably set as the frame-compatible mode.

When the user sets the display mode as the frame-compatible mode (S3), the video signals are output as the 2D mode (S10) when the received stream is 2D (S7); outputs as the frame-compatible mode (S11) when the received stream is a frame-compatible mode (S8); and outputs by being converted into the frame-compatible mode (S11), when the received stream is the service-compatible mode (S9).

The base video post-processing unit 15 and the additional video post-processing unit 17 interwork with the frame memory 16 for base video or the frame memory 18 for additional video, respectively, based on the broadcast service mode and the 3D video format of the received broadcast signal, and the display mode set by the user, thereby performing the frame rate conversion (for example: 30 frame=>60 frame), decimation or interpolation, deinterlacing, noise reduction filtering, and the like.

When the received stream is the side-by-side or top-and-bottom video format and the display mode set by the user is 2D, the base video post-processing unit 15 interworks with the frame memory 16 for base video to perform the interpolation, thereby reconstructing the video signals transmitted from the decoding unit 14 to the original resolution.

When the received broadcast signal is the service-compatible 3D and the display mode set by the user is the frame-compatible 3D, the base video post-processing unit 15 and the additional video post-processing unit 17 each interworks with the frame memory 16 for base video and the frame memory 18 for additional video to perform the decimation, thereby reducing resolution of the video signals transmitted from the decoding unit 14.

The video combining unit 19 reads the video signals stored in the base video frame memory 16 and the additional video frame memory 18 to construct the video signals based on the video mode of the received streams and the display mode set by the user and transmits the constructed video signals to the video output unit 20. When the received streams or the display mode set by the user is 2D, the video signals stored in the base video frame memory 16 are constructed into the 2D video format and then, the video signals are transmitted to the video output unit 20; and when the received streams and the display mode set by the user is 3D, the base video and the additional video stored in the base video frame memory 16 and the additional video frame memory 18, respectively, are constructed into the video format of the display mode set by the user and then, are transmitted to the video output unit 20.

The video output unit 20 receives the audio signals from the decoding unit 14 and the video signals from the video combining unit 19, and constructs the video signals so as to meet the interface standard of the video signals to be displayed, and outputs.

Method of Receiving 3D Digital Broadcast

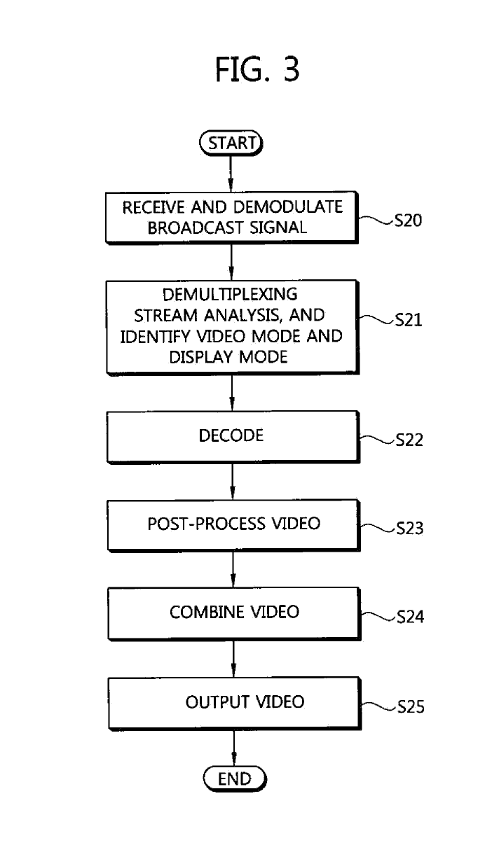

FIG. 3 is a flow chart of a method of receiving 3D digital broadcast according to an exemplary embodiment of the present invention.

A method of receiving 3D digital broadcast according to an exemplary embodiment of the present invention identifies the video mode (at least one of the broadcast service mode, the video format, the information on an elementary stream of the base video, and the information on the elementary stream of an additional video) by analyzing the streams of the received broadcast signals, processes the streams based on the identified video mode and the display mode of the apparatus of receiving broadcast set by the user, and constructs and outputs the video signals based on the identified video mode and the display mode set by the user.

Referring to FIG. 3, the apparatus 10 of receiving 3D digital broadcast receives the broadcast channel selected by the user, performs the demodulation process, and extracts the transport streams of the user desired broadcast program (S20).

The transport streams are demultiplexed. In other words, the broadcast program information including at least one of information on the broadcast service mode, the video format and the encoding type of the elementary streams is acquired and identified, the display mode of the apparatus of receiving broadcast set by the user is identified depending on whether the display apparatus supports the display mode, and the like, and the elementary streams are extracted from the transport streams (S21).

The elementary streams are decoded based on the encoding type of each elementary stream. The audio signals are generated by decoding the audio elementary streams, and in the case of the video elementary streams, the video mode of the received video elementary streams is 2D, the frame-compatible 3D or when the display mode set by the user is 2D, only the base video streams are decoded (S22).

The decoded video signals are post-processed. That is, it interworks with the frame memory to perform the frame rate conversion (for example: 30 frames=>60 frames), the decimation, the interpolation, the deinterlacing, the noise reduction filtering, and the like. The streams of the received broadcast signals are the side-by-side or top-and-bottom video format, and when the display mode set by the user is 2D, it is necessary for the interpolation function to reconstruct the video signals transmitted from the decoder into the original resolution. When the received broadcast signal is the service-compatible 3D and the display mode set by the user is the frame-compatible 3D, it is necessary for the decimation to reduce the resolution of the video signals transmitted from the decoder (S23). The post-processed video signals are stored in the frame memory.

The video signals stored in the frame memory are read and are thus constructed based on the video mode of the received streams and the display mode set by the user (S24).

The video signals (generated in S24) combined with the decoded audio signals (generated in S22) so as to meet the interface standard of the video signals to be displayed are constructed and output to the display apparatus (S25).

Apparatus and Method of Converting Video Mode.

As set forth above, the present invention may be implemented as the apparatus of receiving a broadcast, and implemented as the apparatus of converting a video mode included in the apparatus of receiving a broadcast according to the related art having the receiving and demodulating functions of the broadcast signals.

The apparatus of converting the video mode according to the embodiment of the present invention may include the demultiplexing unit that extracts the broadcast program information and the elementary streams from the transport streams of the broadcast signals and the video processing unit that processes the elementary streams and constructs the video signals based on the extracted broadcast program information and the display mode setting of the apparatus of receiving broadcast.

In addition, the method of converting a video mode according to another embodiment of the present invention may include performing demultiplexing to extract the broadcast program information and the elementary streams from the transport streams of the broadcast signals, and processing a video to process the elementary streams and construct the video signals, based on the extracted broadcast program information and the display mode setting of the apparatus of receiving a broadcast.

The spirit of the present invention has been just exemplified. It will be appreciated by those skilled in the art that various modifications and alterations can be made without departing from the essential characteristics of the present invention. Accordingly, the embodiments disclosed in the present invention and the accompanying drawings are used not to limit but to describe the spirit of the present invention. The scope of the present invention is not limited only to the embodiments and the accompanying drawings. The protection scope of the present invention must be analyzed by the appended claims and it should be analyzed that all spirit within a scope equivalent thereto are included in the appended claims of the present invention.

1. An apparatus of receiving a broadcast, comprising:
a broadcast signal receiving and demodulating unit that receives and demodulates broadcast signals to extract transport streams;
a demultiplexing unit that extracts broadcast program information and elementary streams from the extracted transport streams; and
a video processing unit that processes the elementary streams and constructs video signals, based on the extracted broadcast program information and display mode setting of the apparatus of receiving broadcast.

2. The apparatus of claim 1, wherein the broadcast program information includes at least one of information on a video mode of the received broadcast signals and information on an encoding type of elementary streams.

3. The apparatus of claim 2, wherein the information on the video mode includes at least one of information on a broadcast service mode, information on a video format, information on elementary streams of a base video, and information on elementary streams of an additional video.

4. The apparatus of claim 1, wherein the demultiplexing unit analyzes at least one of a program map table (PMT) in the extracted transport streams, user_data within packetized elementary streams (PESs) or a frame packing arrangement SEI message, and extracts information on the video mode of the received broadcast signals.

5. The apparatus of claim 1, wherein the video processing unit constructs 2D video signals when the display mode setting of the apparatus of receiving a broadcast is 2D even if the extracted transport streams are 3D.

6. The apparatus of claim 1, wherein the video processing unit processes the elementary streams based on the broadcast program information and the display mode setting of the apparatus of receiving a broadcast when the extracted transport streams are 3D, and
constructs the video signals based on the processed elementary streams and the display mode setting of the apparatus of receiving a broadcast.

7. The apparatus of claim 1, wherein the video processing unit performs an interpolation function for reconstructing the video signals into original resolution, when the extracted transport streams are 3D video transport streams with reduced original resolution and the display mode setting of the apparatus of receiving a broadcast is 2D.

8. The apparatus of claim 1, wherein the video processing unit performs a decimation function for converting the service-compatible 3D video signals into the frame-compatible 3D video signals, when the extracted transport streams are the service-compatible 3D video transport streams and the display mode setting of the apparatus of receiving a broadcast is the frame-compatible 3D mode.

9. The apparatus of claim 1, wherein the video processing unit includes:
a decoding unit that decodes the elementary streams, based on the broadcast program information obtained by the demultiplexing unit;
a base video post-processing unit that post-processes a base video by interworking the base video frame memory;
an additional video post-processing unit that post-processes an additional video by interworking the additional video frame memory;
a video combining unit that reads the video signals at least one of the base video frame memory or an additional video frame memory, and constructs the video signals of video format to be displayed; and
a video output unit that constructs and outputs the video signals so as to meet an interface standard of the video signals to be displayed.

10. A method of receiving broadcast, comprising:
receiving and demodulating broadcast signals to extract transport streams;
performing demultiplexing to extract broadcast program information and elementary streams from the extracted transport streams; and
processing video to process the elementary streams and construct video signals, based on the extracted broadcast program information and display mode setting of an apparatus of receiving a broadcast.

11. The method of claim 10, wherein the broadcast program information includes at least one of information on a video mode of the received broadcast signals and information on an encoding type of the elementary streams.

12. The method of claim 11, wherein the information on the video mode includes at least one of a broadcast service mode, a video format, information on elementary streams of a base video, and information on elementary streams of an additional video.

13. The method of claim 10, wherein in the demultiplexing, at least one of a program map table (PMT) in the extracted transport streams, user_data within packetized elementary streams (PESs) or a frame packing arrangement SEI message is analyzed, and information on the video mode of the received broadcast signals is extracted.

14. The method of claim 10, wherein in the processing of the video, 2D video signals are constructed when the display mode setting of the apparatus of receiving a broadcast is 2D even if the extracted transport streams are 3D.

15. The method of claim 10, wherein in the processing of the video, the elementary streams are processed based on the broadcast program information and the display mode setting of the apparatus of receiving broadcast when the extracted transport streams are 3D, and
the video signals are constructed based on the processed elementary streams and the display mode setting of the apparatus of receiving a broadcast.

16. The method of claim 10, wherein in the processing of the video, an interpolation function for reconstructing the video signals into original resolution is performed when the extracted transport streams are 3D video transport streams with reduced original resolution and the display mode setting of the apparatus of receiving broadcast is 2D.

17. The method of claim 10, wherein a decimation function for converting the service-compatible 3D video signals into the frame-compatible 3D video signals is performed, when the extracted transport streams are service-compatible 3D video transport streams and the display mode setting of the apparatus of receiving a broadcast is frame-compatible 3D mode.

18. The method of claim 10, wherein the processing of the video includes:
decoding the elementary streams, based on the broadcast program information obtained in the demultiplexing;
post-processing a base video by interworking the base video frame memory;
post-processing an additional video by interworking the additional video frame memory;
performing combining video by reading the video signals of at least one of the base video frame memory or an additional video frame memory, and construct the video signals of video format to be displayed; and
constructing and outputting the video signals so as to meet an interface standard of the video signals to be displayed.

19. An apparatus of converting a video mode, comprising:
a demultiplexing unit that extracts broadcast program information and elementary streams from transport streams of broadcast signals; and
a video processing unit that processes the elementary streams and constructs video signals, based on the extracted broadcast program information and display mode setting of an apparatus of receiving a broadcast.

20. A method of converting a video mode, comprising:
performing demultiplexing to extract broadcast program information and elementary streams from transport streams of broadcast signals; and
processing video to process the elementary streams and construct video signals, based on the extracted broadcast program information and the display mode setting of the apparatus of receiving a broadcast.
